(19) United States
(12) Patent Application Publication
(10) Pub. No.: US 2012/0255747 A1
(43) Pub. Date: Oct. 11, 2012

(54) Hand Tool for Edging or Trenching

(76) Inventors: Michael Weaver, Hastings, NY (US); William Weaver, Hastings, NY (US)

(21) Appl. No.: 13/440,302

(22) Filed: Apr. 5, 2012

Related U.S. Application Data
(60) Provisional application No. 61/472,219, filed on Apr. 6, 2011.

(51) Int. Cl. A01B 1/00; A01G 3/06

(52) U.S. Cl. 172/18

(57) ABSTRACT

An hand tool for trenching or edging is in the form of an open loop, with a digging head at its lower end and a split handle portion with left and right shafts and a transverse grip. The head is formed of a transverse cross bar with a curvilinear blade flat blade that extends about eight to ten inches below the cross bar. This may be a semi-circular blade, such as one-half of a fluted coulter disk. The upper part of the cross bar, between left and right handle shaft portions, forms a step or foot plate where the worker can step to bear down over the center of the blade. The tool may be used in trenching for laying cables or conduit.

Applicants claim priority of their Provisional Application Ser. No. 61/472,219, filed Apr. 6, 2011, the disclosure of which is incorporated by reference herein.

### BACKGROUND OF THE INVENTION

The present invention relates to hand tools, such as shovels or spades that are used for digging into the earth, and is more specifically directed to a tool that may be used for digging a narrow trench or slot, e.g., for laying service conduit or cables. The tool may also be used as an edging tool at a transition from lawn to walkway or lawn to garden.

The invention is more particularly concerned with a tool that has a cutting or digging head portion at its lower end, a grip at the upper end for the worker's hands, and where a split shaft connects the grip to ends of the digging head portion, and where a central step or foot plate is provided for the worker to step and bear down directly over the center of the blade. There is a need for a trenching tool for the laying of service lines in the earth, i.e., buried or subterranean electrical or communication cables, television cables, or fiber optic cables to lead to a terminal box or post at a residence or commercial building. For many applications a power trencher tool is used (usually a walk-behind power trencher) to dig the trench in a straight line through a lawn or similar surface. However, it is not possible to employ a power trencher within a few feet of a building or fence or near the termination box or post. At those places, a trench must be hand-dug, but there has not been any suitable tool to form a thin linear trench in those places. Shovels and spades typically have a curved blade and this makes it difficult to dig a straight slot-like trench. Other flat gardening tools have a blade that is too narrow to be effective. Also, with the above listed tools, foot pressure can only be applied at the left or right side, and so these are less effective in penetrating through roots or other obstructions in the soil.

### SUMMARY OF THE INVENTION

According to an aspect of the invention, the hand tool is in the form of a head portion and handle portion, with the head portion, at the lower end, including a transverse cross bar and a semicircular blade welded or otherwise affixed to the crossbar and oriented downwards. The handle portion has a transverse grip bar at its upper end and a split shaft with left and right shaft portions extending from the ends of the grip bar to respective ends of the head portion crossbar. A portion of each of the shaft members can be formed of an insulating fiberglass material, to protect the worker in the case of inadvertent cutting of an electric cable. Favorably, the semicircular blade may take the form of one half of a fluted coulter blade, of the type used in agricultural applications. This may have a diameter, e.g., of seventeen inches, so the blade has a penetration depth of about eight to ten inches into the earth. The upper part of the crossbar, between the left and right handle shaft portions, can form a step or foot plate where the worker can step to bear down directly over the center of the semicircular blade. As a result, the tool cuts easily through tree roots and similar obstructions to facilitate completing the trench. The tool may also be used as an edger.

The edging or slotting tool need not have the exact form of the described embodiment.

The principles of this invention can comprise the tool formed with a head portion and a handle portion, with the head portion including a transverse cross bar, a flat, planar blade that is secured to the cross bar and projects downward. The blade need not be circular or semicircular, but can be a suitable shape having a curvilinear peripheral edge that extends down at each side from the cross bar to a lower curved cutting edge. There are left and right projections that respectively extend upward from left and right ends of the cross bar and to which the handle portion is affixed. The projections defining an unobstructed clearance at the upper side of the cross bar and between the two projections, with the clearance being a central open portion of the cross bar, so that the cross bar can be used as a step or foot plate to receive the user's foot at the center of the cross bar.

In one alternative embodiment, the head portion may be formed with the two vertical projections bending to center to form a D-shape (or delta shape) with the cross bar, and with a socket member to receive a single central handle shaft.

A wavy coulter blade or blade with flat surface geometry may be used. The blade may be of a semi-elliptical shape, in some cases. The shaft of the handle may be formed of a fiber-glass reinforced plastic resin, but a wood shaft may be used. The transverse grip need not be a straight horizontal member, but may be curved or angulated. In some embodiments, the grip may be in the form of a straight or bent portion of the shaft, or may incorporate a D-handle.

The above and other features and advantages of this invention will be appreciated from the ensuing description of a preferred embodiment, and variations thereof, which are offered as illustrative examples.

### BRIEF DESCRIPTION OF THE DRAWING

FIG. 1 is a front elevation view of a hand tool according to one embodiment of the invention, here shown with dimensions of its elements as employed in one preferred embodiment.

FIG. 2 is another front elevation thereof, the rear elevation being similar or a mirror image.

FIG. 3 is an enlargement of the head portion thereof.

FIG. 4 is a side view, taken at 4-4 of FIG. 2.

FIG. 5 is a lower end view of the head portion thereof, taken at 5-5 of FIG. 2.

FIGS. 6, 7 and 8 are partial elevational views of a few of many possible alternative embodiments of this invention.

### DETAILED DESCRIPTION

The digging tool 10 of one preferred embodiment, i.e., trenching or edging tool, is here in the shape of a generally rectangular open loop, with a digging head portion 12 at the lower end, and a split handle portion 18. The head portion is formed of a transverse cross bar 14, formed of steel tubing of 1¼ inch diameter, and a semicircular or half-disk blade 16 that is welded in place into the crossbar 14 and that extends downward below it. In this embodiment, the blade is one half of a seventeen-inch diameter coulter blade.

The handle portion 18 has a transverse handle grip 20 here formed of tubular steel of 1¼ inch diameter. There are left and right shafts 21 that extend from the grip 20 to the head portion 12. At the upper part of the shafts are upper left and right shaft socket members 22 respectively that that formed at the ends of the grip 20. In this case these socket members are formed by bending into ninety-degree ells. Each of these has a bell or flare 24 to accommodate an upper end of an insulating (e.g., fiberglass) shaft section 26. There are left and right lower shaft portions 28, formed as upwardly extending tubular projections, welded or formed at or near the left and right ends of the transverse crossbar 14, and these extend upward from the ends of the crossbar 14. Each of these portions 28 has a bell or flare 30 formed at its upper end to accommodate the lower end of the respective insulating shaft section 26. Fiberglass is preferred but other suitable materials may be used.

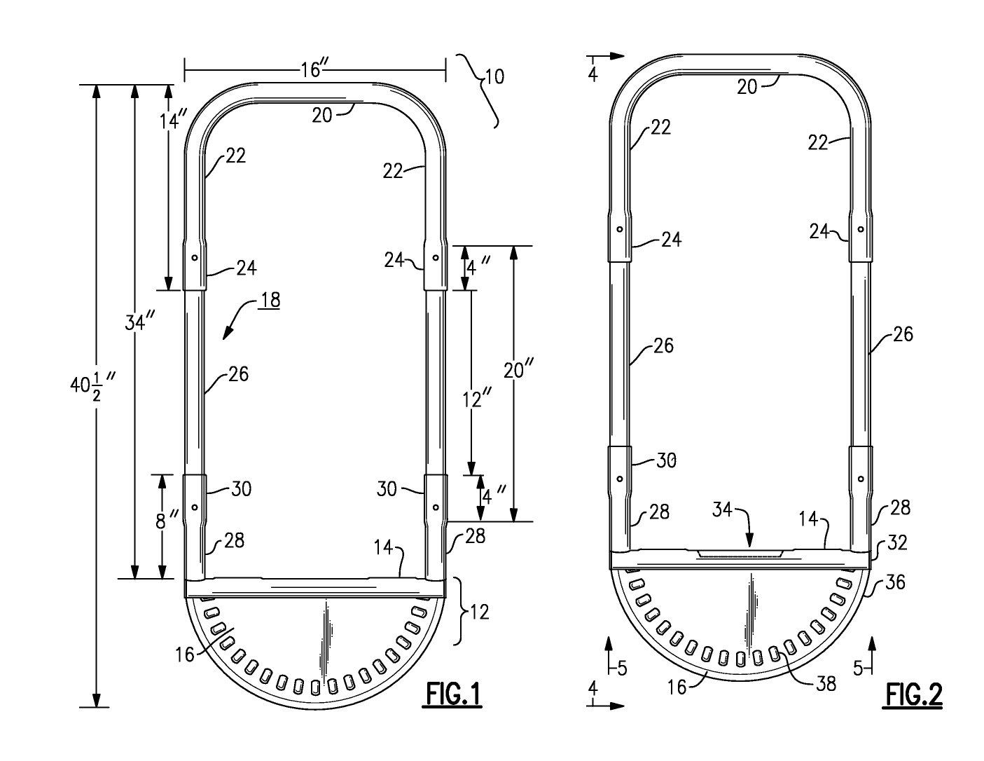

As shown in FIGS. 2 and 4 there are circular end plates 32 closing off the right and left ends of the tubular crossbar 14.

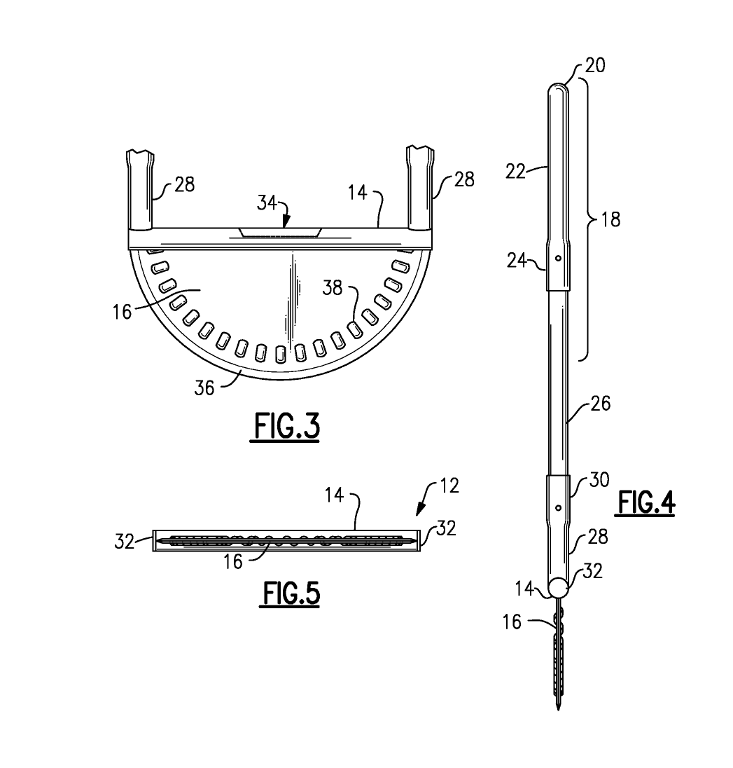

As shown also in FIGS. 2 and 3, because of the split handle or split shaft construction, there is an unobstructed step area or foot plate portion 34 centered at the upper side of the crossbar 14. A worker can step here to bear down directly over the center of the semicircular blade 16. The blade may be rocked as need be to cut through roots or other obstructions in the soil, and provide a slot for installation of buried cable or conduit.

As also shown in FIGS. 2 and 3, the blade 16 has an arcuate tapered or sharpened edge 36, and there is fluting 38 in the form of radial ridges and grooves within the zone of the edge 36.

FIGS. 4 and 5 also show the relative dimension of the blade 16 thickness to the transverse cross bar 14

The dimensions of the preferred embodiment are shown in FIG. 1. However, other dimensions are possible without departing from the principles of my invention. Also other materials could be used. A wavy blade rather than a fluted coulter blade could be used in some applications, and a planar flat blade could be employed in other applications. Steel is used here for the major components (aside from the insulating shaft portions 26), but advanced plastic resins or other materials could be employed if desired.

Several variants of the tool of this invention are illustrated in FIGS. 6, 7 and 8, in which similar elements to those shown in the first embodiment are identified with similar reference numbers, but raised by 100, 200, or 300, respectively.

In the FIG. 6 embodiment, the tool 110 has left and right vertical projections 128, 128 that are welded to the ends of the cross bar 114 to which the semicircular blade 116 is affixed. These projections rise and then bend to meet a transverse member 140, thus forming a D-shaped head with the cross bar 114. This D-shaped configuration provides an opening or clearance for the user to place his or her foot upon the center of the cross bar, as with the first embodiment. Here, a handle socket or bell flare 130 is affixed at the center of the transverse member 140, and the shaft 126 is affixed into this bell flare 130. Here, only the lower portion of the shaft 126 is shown. The shaft is to be understood to extend upwards, and to have a handle or grip member attached at its upper end. This may be a T-handle or D-handle.

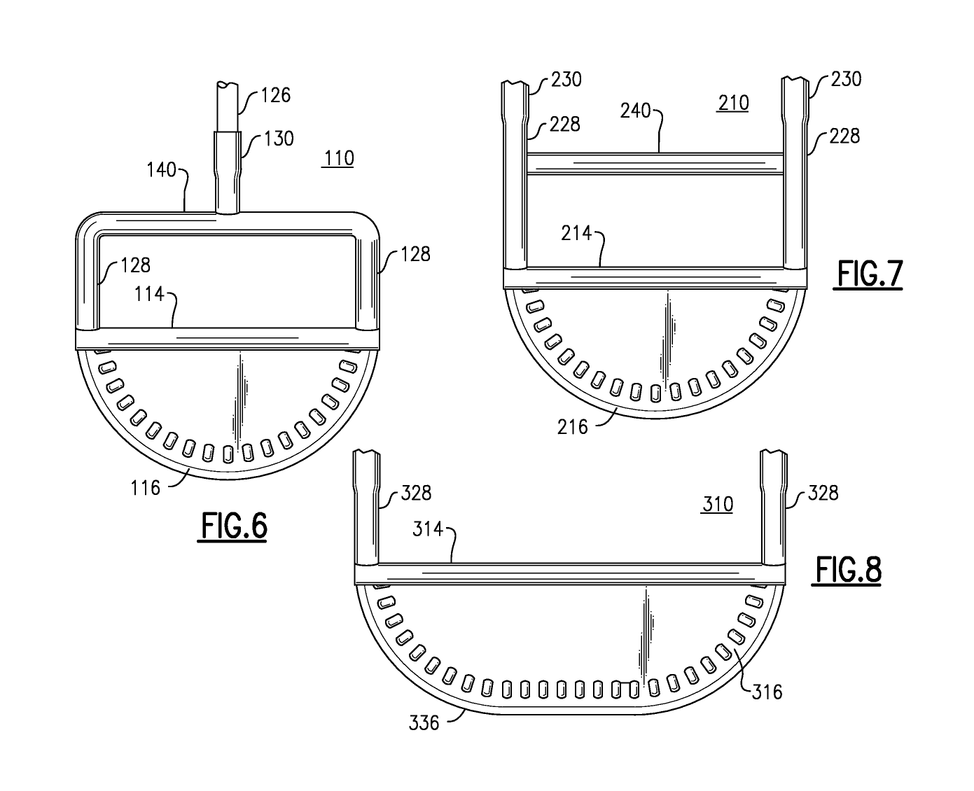

Another alternative embodiment as shown in FIG. 7, in which the tool 210 has a blade 216, cross bar 214, left and right lower shaft portions 228 and bell flares 230, similar to the construction of the first embodiment. In this embodiment a second cross bar 240 or transverse member is affixed to the shaft portions 228 at or near the junction with the bell flares 230. There is an open area or clearance defined between the shaft portions 228 and between the first and second transverse cross bars 214 and 240, with the dimensions thereof being sufficient to accommodate the foot of a user, so that he or she may place the foot on the center of the cross bar 214. In this case, the upper cross bar 240 may also be used as a foot plate in the same manner, which may provide an advantage in some applications. Here, the tool can employ a split handle, with left and right shaft portions as in the first embodiment.

The embodiment of the tool 310 illustrated in FIG. 8 is identical to the construction of the first embodiment, except that the blade 316 is of a more-or-less oblong, i.e., semi-oval or semi-elliptical shape, so that its cutting edge 336 follows a curvilinear path that extends down from the left and right ends of the cross bar 314, then curves inward, and follows a less sharply curved line at its central, lower part. The vertical lower shaft portions 328 are shown, but the remainder of the handle portion of the tool is omitted in this view. The depth of the blade is preferably in the same range of eight to ten inches as other embodiments, but may vary from this, depending on the type of cable or conduit installation, or depending upon the terrain.

While this invention has been described with respect to a few selected embodiments, it should be understood that the invention is not limited to those embodiments, and that the scope of the invention is defined by the appended Claims.

I Claim:

1. A hand tool for digging a narrow slot or trench in the earth, comprising a head portion disposed at a lower end of the tool and a handle portion that extends upward from the head portion;
the head portion including a transverse cross bar, a flat, planar blade that is secured to the cross bar and projects downward therefrom, the blade having a curvilinear peripheral edge extending down at each side from the cross bar to a lower curved cutting edge; and left and right projections that respectively extend upward from left and right ends of the cross bar and to which the handle portion is affixed, the projections defining an unobstructed clearance at the upper side of the cross bar therebetween adapted to be used as a step or foot plate to receive the user's foot at the center of the cross bar.

2. The hand tool of claim 1 wherein said handle portion includes a transverse grip bar at an upper end of the handle portion and left and rightshaft members that extend from said transverse grip bar to corresponding left and right projections of the head portion.

3. The hand tool of claim 2 wherein said left and right shaft members extend from respective ends of said transverse grip bar.

4. The hand tool of claim 2 wherein the left and right shaft portions each include an upper tubular member joined to the respective end of the grip bar and an insulating shaft member connecting the upper tubular member to a respective one of the left and right projections of the head member.

5. The hand tool of claim 1 wherein said blade is semicircular.

6. The hand tool of claim 1 wherein said blade is semi-elliptical.

7. The hand tool of claim 1 wherein said blade has a penetrating depth of substantially eight inches to ten inches.

8. The hand tool of claim 1 wherein said left and right projections bend towards a center and form a D-shaped member defining said unobstructed clearance, and having a central shaft socket, and wherein said handle portion includes a shaft member affixed to said central shaft socket.

9. A hand tool for digging a narrow slot or trench in the earth, comprising:
a head portion disposed at a lower end of the tool and including
a transverse cross bar and
a semicircular flat blade secured to the cross bar and projecting downward; and
a handle portion that includes
a transverse grip bar at an upper end of the tool and
left and right shaft members that extend from respective ends of the grip bar downward to corresponding end portions of the head portion cross bar.

10. The hand tool of claim 9 wherein said shaft portions each include an upper and a lower steel tubular member joined respectively to the grip bar and to the head portion cross bar; and which are separated from one another by an insulating shaft member.

11. The hand tool of claim 9 wherein said blade is in the form of one-half of a circular coulter blade.

12. The hand tool of claim 9 wherein said blade is in the form of one-half of a circular fluted coulter blade.

13. The hand tool of claim 9 wherein said blade has a penetrating depth of substantially eight inches to ten inches.

14. The hand tool of claim 9 wherein the tool has the shape of an open rectangular loop.
